(19) United States
(12) Patent Application Publication
(10) Pub. No.: US 2006/0062632 A1
(43) Pub. Date: Mar. 23, 2006

(54) Release pin assembly for tents and canopies

(75) Inventor: Jung-Woo Jang, Changu Yung Sun (KR)

Correspondence Address: Greenberg Traurig, LLP;Suite 400E, 2450 Colorado Avenue, Santa Monica, CA, 90404, US

(73) Assignee: Norstar Trade, Inc.

(21) Appl. No.: 10/943,622

(22) Filed: Sep. 17, 2004

(51) Int. Cl. F16B 7/10

(52) U.S. Cl. 403/109.6; 403/378

(57) ABSTRACT

A release pin assembly for locking telescoping poles of a tent or canopy or the like. The assembly friction fits along the telescoping poles and includes a spring biased release pin which extends into aligned holes in the poles. The pin is coupled to a quick release lever which is pivoted from a first position where the pin extends into locking engagement with the holes to a second position out of locking engagement with the poles allowing the same to be extended to different positions.

### BACKGROUND OF THE INVENTION

1. Field of the Invention

The invention relates to a release pin assembly; and, more particularly, to a release pin assembly for telescoping poles of a tent or canopy or the like.

2. Related Art

Portable tents and canopies are known which have a frame comprised of telescoping support legs or poles. These poles can be locked in differing extended positions so that the overall height of the tent or canopy can be adjusted.

Generally, locking pins for such adjustable poles include pins which extend into aligned holes in the telescoped poles to lock them in position. In one known embodiment, one pole is held in a telescoped position by one's hand while the other pole is held by the user's other hand. A third party is thus necessary to insert the pin into the aligned poles to lock them in position.

There is a need for a release pin assembly which can be actuated by the user holding the poles in a telescoped position prior to locking the same.

### SUMMARY OF THE INVENTION

It is an object of this invention to provide a release pin assembly for telescoping poles of a tent or canopy that can be actuated by a single user.

It is a further object of this invention to provide such an assembly that moves a locking pin into and out of engagement with aligned holes in telescoping poles by pivoting a lever attached to the locking pin. These and other objects are preferably accomplished by providing a release pin assembly which friction file along telescoping supporting poles of a tent or canopy and includes a spring biased release pin which extends into aligned holes in the poles. The pin is coupled to a quick release lever which is pivoted from a first position where the pin extends into locking engagement with the holes to a second position out of locking engagement with the poles allowing the same to be extended to different positions.

### BRIEF DESCRIPTION OF THE DRAWINGS

FIG. 1 is a perspective view of a tent or canopy incorporating the release pin assembly of the invention;

FIG. 2 is a perspective view of a portion of one of a pair of the telescoped poles of the tent or canopy of FIG. 1 having the release pin assembly of the invention mounted thereon;

FIG. 3 is a perspective view of the release pin assembly alone;

FIG. 4 is an elevational view of the assembly of FIG. 2 showing the release lever in an unlocked position;

FIG. 5 is a view similar to FIG. 4 showing the release lever in a locked position;

FIG. 6 is a cross-sectional view of the assembly of FIG. 5; and

FIG. 7 is a cross-sectional view taken along line 7-7 of FIG. 6.

### DETAILED DESCRIPTION OF THE PREFERRED EMBODIMENT

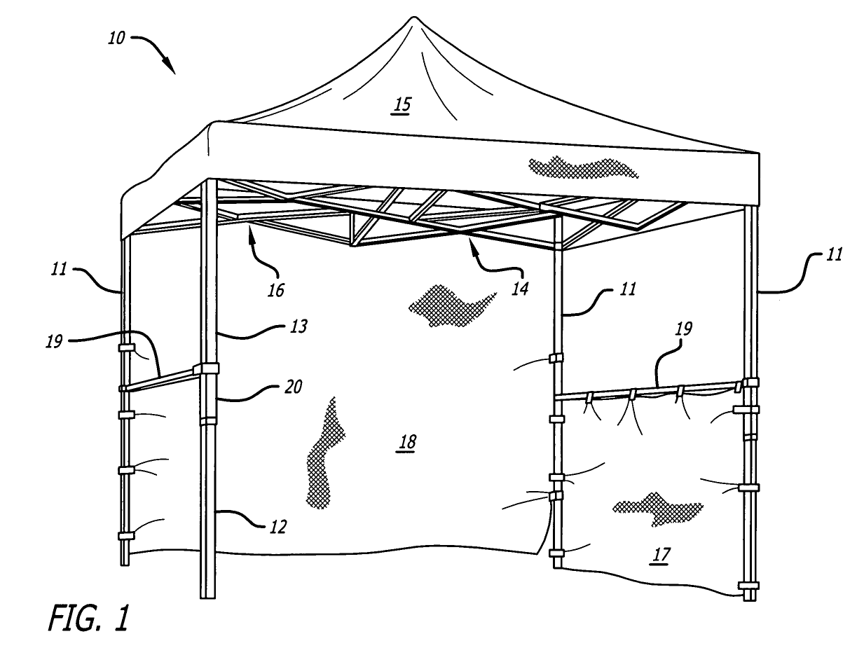

A portable canopy or tent 10 is shown in FIG. 1. Such tents generally have a plurality of uprights 11 each comprised of telescoping poles 12, 13. Tent 10 may have a frame 14 covered by a canopy 15. Frame 14 may be comprised of expandable scissor-like members 16 and side panels 17, 18 may cover the uprights 11. Side rails 19 may be used between uprights 11 for further support.

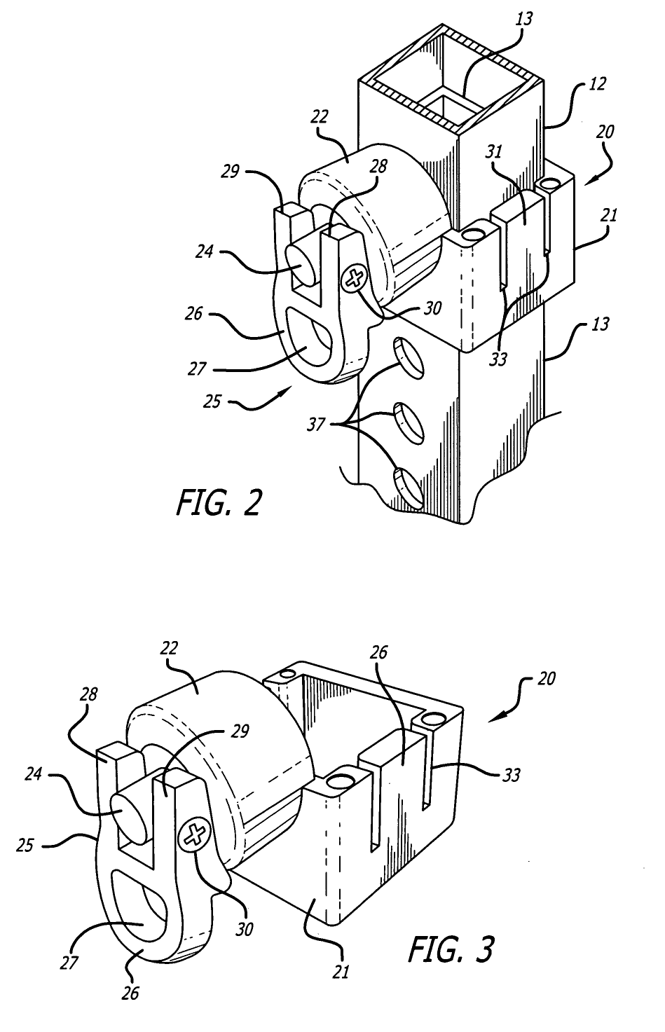

As seen in FIG. 2, one pole, such as pole 13, telescopes within the other (i.e., pole 12). A plurality of vertically adjustable locking means 20 are provided on each set of uprights 11 for locking poles 12, 13 in a desired expanded position.

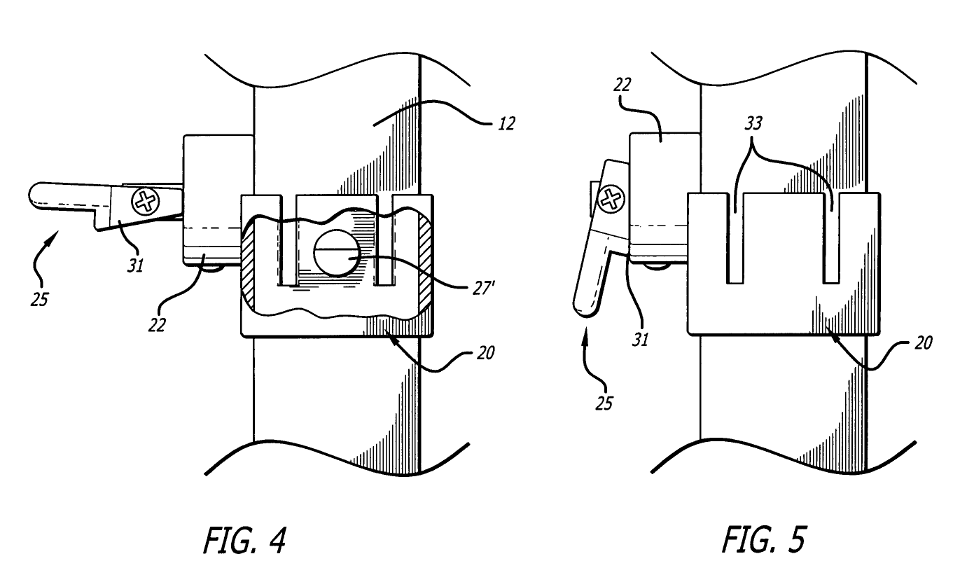

As seen in FIG. 2, each pole 12, 13 is generally square in cross-section and, thus, locking means 20 includes a generally square shaped main body portion 21 fit over one end of pole 12 of one the uprights 11 of tent 10. A resilient tab 31 is cut out from main body portion 21 by pair of spaced slots 33 and a boss 27′ (FIG. 4) on the interior of tab 31 is adapted to abut against the exterior of outer pole 12 and frictionally hold locking means 20 in position on pole 12. That is, locking means 20 is frictionally held to pole 12 and is also frictionally fit to the same, the boss 27′ ensuring that main body portion 21 is securely fit to pole 12 without necessity for precise tolerances. Also, as in evident in FIG. 3, a similar tab and slots, along with a boss, are provided on the opposite side of main body portion 21. Of course, the number of tabs 31 may be varied.

A release pin body member 22, FIG. 3, integral with main body portion 21, extends radially outwardly from main body portion 21. A release lever 25 is pivotally connected to a pin 24 (as will be discussed) extending through main body portion 21. Release lever 25 may be A-shaped having a curved lower body portion 26, having a D-shaped opening 27 therethrough, and spaced upper leg portions 28, 29 through which pin 24 extends. Release lever 25 is secured to pin 24 by a transversely extending locking pin 30 extending through legs 28, 29 and pin 24. Release lever 25 may have an enlarged portion 31 (FIGS. 4 and 5) which abuts against body member 22 when pivoted or rotated to the FIG. 5 position.

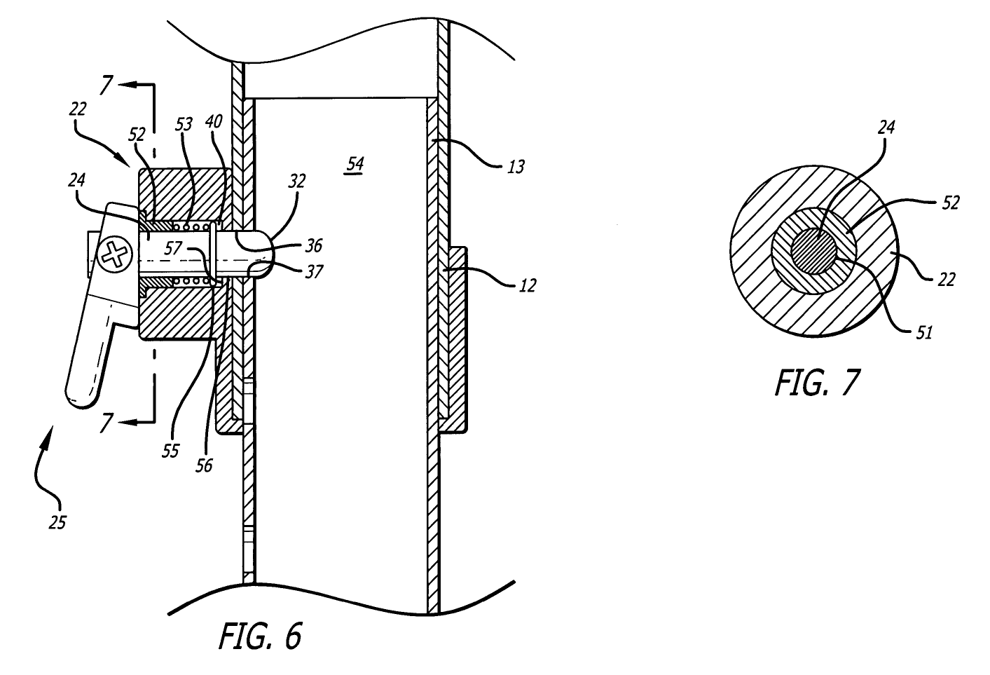

As can be understood by referring to FIGS. 2 to 5, release lever 25 rotates about pin 24 and can be pivoted from the position shown in FIG. 2 (where pin 24 extends into locking engagement with aligned holes 36, 37 hole 36 in outer pole 12 and hole 37 in inner pole 13), -see also FIG. 6- to the position shown in FIG. 4, where pin 24 is retracted from locking engagement in holes 36, 37 to the position shown in FIG. 5 (where pin 24 is again in locking position in holes 36, 37).

Pin 24 may be of any suitable configuration, such as cylindrical, and may have a rounded head 32 (FIG. 6). It is generally configured similarly to holes 36, 37 but may of course be square-shaped with holes 36, 37 similarly configured.

As seen in FIG. 6, pin 24 is shown in the FIG. 4 position (not disposed in holes 36, 37). Pin 24 is slidably contained inside body portion 22 within a space 40 and a hole 51 (FIG. 7) in a plug 52 centrally located in body portion 22. Plug 52 is countersunk and preferably friction fits into body portion 22 to maintain its position. A spring 53 acts as a bearing member to bias pin 24 toward the first position in which pin 24 extends into the central space 54 inside of pole 13 (the FIGS. 2 and 5 position of pin 24). Spring 53 acts between the inner surface 53 of plug 52 and a circumferential stop 55 on pin 24. A hole 56 is provided at the end of space 40. Hole 56 is surrounded by a circumferential ledge 57 having a circumference substantially the same as space 40. Hole 56, as seen in FIG. 6, is aligned with holes 36, 37, in poles 12, 13 respectively.

Stop 55 of course prevents pin 24 from extending too far past holes 36, 37 by abutting against ledge 57.

When pin 24 is in the FIG. 4 position, poles 12, 13 are free to move relative to one another and the uprights 11 can be extended or collapsed, as desired. Pin 24 is moved by of course pivoting release lever 25 from the FIG. 4 to the FIG. 5 or to the FIG. 2 position whereby pin 24, under bias of spring 54, enters aligned holes 36, 37 and locks the poles 12, 13 in position. The pole 13 may have a plurality of holes, such as holes 37 in FIG. 2, so the poles can be locked in a variety of extended positions.

As previously indicated, poles 12, 13, body member 21 and pin 24 may be of any suitable configuration. The release lever 25 can be pivoted between locking and unlocking positions by merely engaging portion 26. In this manner, poles 12, 13 can be held by the operator in his or her's respective hands and pulled or retracted to a desired position. When holes 36, 37 are aligned, the user can move release lever 25 with his or her foot thus locking the poles in the desired telescoped position without need for a “third hand”. Thus, the embodiment disclosed herein has a major advantage over prior known devices which require one to pull a ring or the like. One person can operate the structure disclosed herein.

Although a single locking means 20 is disclosed, obviously one or more may be provided, connected to each other, with suitable telescoping poles extending therethrough. Any suitable materials may be used, such as metal, plastics, etc. The dimensions may vary but are or course dependent on the dimensions of the poles.

The main body portion 21 is preferably of resilient material so that the cut-out tabs 31 and boss 27′ allow the same to grasp the outer pole 12 in a friction fit relationship.

Although a particular embodiment of the invention is disclosed, variations may occur to an artisan and the scope of the invention should only be limited by the scope of the appended claims.

1. A release pin assembly for locking a pair of hollow telescoping poles supporting a tent or canopy at top in a plurality of fixed, vertically adjustable positions wherein said poles have a predetermined cross-section and one of said poles telescopes within the other of said poles and each of said poles have aligned holes therethrough, the assembly comprising:
said release pin assembly including a main body portion having a central aperture therethrough mounted on and conforming to the outer configuration of said other of said poles and encircling the same, said one of said poles having an elongated central axis;
said main body portion including a release pin body portion with a release pin extending through an opening in said release pin body portion and reciprocal therein, said opening being aligned with said aperture and said release pin having a forward end and a distal end and movable from a first position wherein said forward end extends within said opening and through said central aperture and into aligned holes in said poles terminating before extending to the central longitudinal axis of said one of said poles to a second position with said forward end extending out of said central aperture and out of said aligned holes in said poles thereby allowing reciprocal telescoping movement of said poles; and
a release lever fixed to the distal end of said pin, said lever being pivotable about said release pin from a first position wherein said forward end of said pin extends within said opening and through said central aperture to a second position wherein the forward end of said pin extends out of said central aperture and out of said aligned holes in said poles.

2. The assembly of claim 1 wherein said main body portion has a plurality of interconnected walls, and a resilient tab cut out of at least one of said walls providing a friction fit of said pole to said main body portion.

3. The assembly of claim 2 wherein said tab has an interior portion facing said central aperture, and a boss extending outwardly therefrom into said central aperture abutting against said pole to provide a friction fit.

4. The assembly of claim 1 wherein said release pin is spring biased in a direction toward said central aperture.

5. The assembly of claim 1 wherein said release lever includes a handle portion and a yoke portion, the distal end of said release pin extending through said yoke portion.

6. The assembly of claim 1 wherein said release lever has a first generally flat side disposed away from said central aperture when said release pin extends into said central aperture and an enlarged portion on a second side also disposed away from said central aperture when said release pin extends into said central aperture.

7. The assembly of claim 6 wherein said release pin has a longitudinal axis and said release lever has a plane extending therethrough extending generally normal to said longitudinal axis of said release pin when said release lever is a position whereby said release pin extends into said central aperture.

8. The assembly of claim 7 wherein the plane of said release lever extends generally parallel to the longitudinal axis of said release pin when said release pin extends out of said central aperture.

9. A release pin assembly for locking a pair of hollow telescoping poles supporting a tent or canopy at top in a plurality of fixed, vertically adjustable positions wherein said poles have a predetermined cross-section and one of said poles telescopes within the other of said poles and each of said poles have aligned holes therethrough, the assembly comprising:
said release pin assembly including a main body portion having a central aperture therethrough mounted on and conforming to the outer configuration of said other of said poles and encircling the same, said one of said poles having an elongated central axis;
said main body portion including a release pin body portion with a release pin extending through an opening in said release pin body portion and reciprocal therein, said opening being aligned with said aperture and said release pin having a forward end and a distal end and movable from a first position wherein said forward end extends within said opening and through said central aperture and into aligned holes in said poles terminating before extending to the central longitudinal axis of said one of said poles to a second position with said forward end extending out of said central aperture and out of said aligned holes in said poles thereby allowing reciprocal telescoping movement of said poles; and
a release lever fixed to the distal end of said pin, said lever being pivotable about said release pin from a first position wherein said forward end of said pin extends within said opening and through said central aperture to a second position wherein the forward end of said pin extends out of said central aperture and out of said aligned holes in said poles.

10. The assembly of claim 9 wherein said main body portion has a plurality of interconnected walls, and a resilient tab cut out of at least one of said walls providing a friction fit of said pole to said main body portion.

11. The assembly of claim 10 wherein said tab has an interior portion facing said central aperture, and a boss extending outwardly therefrom into said central aperture abutting against said pole to provide a friction fit.

12. The assembly of claim 9 wherein said release pin is spring biased in a direction toward said central aperture.

13. The assembly of claim 9 wherein said release lever includes a handle portion and a yoke portion, the distal end of said release pin extending through said yoke portion.

14. The assembly of claim 9 wherein said release lever has a first generally flat side disposed away from said central aperture when said release pin extends into said central aperture and an enlarged portion on a second side also disposed away from said central aperture when said release pin extends into said central aperture.

15. The assembly of claim 14 wherein said release pin has a longitudinal axis and said release lever has a plane extending therethrough extending generally normal to said longitudinal axis of said release pin when said release lever is a position whereby said release pin extends into said central aperture.

16. The assembly of claim 15 wherein the plane of said release lever extends generally parallel to the longitudinal axis of said release pin when said release pin extends out of said central aperture.
